(19) United States
(12) Patent Application Publication
(10) Pub. No.: US 2013/0303290 A1
(43) Pub. Date: Nov. 14, 2013

(54) DEVICE FOR PROVIDING A GAME

(71) Applicant: DENA CO., LTD., Tokyo (JP)

(72) Inventors: Yoshihisa NISHIYA, Tokyo (JP); Takatomo OKITSU, Tokyo (JP)

(73) Assignee: DeNA Co., Ltd., Tokyo (JP)

(21) Appl. No.: 13/890,835

(22) Filed: May 9, 2013

(30) Foreign Application Priority Data
May 14, 2012 (JP) 2012-110619

(51) Int. Cl. A63F 13/00

(52) U.S. Cl. CPC A63F 13/00
USPC 463/42

(57) ABSTRACT

One object is to provide a video game that attracts game players to a real sports game. A server device according to one aspect is connected to a terminal device of a game player via a communication network and configured to provide a video game to the terminal device. The server device includes: a setting unit configured to set, as a specific event, an event designated by the terminal device among events anticipated in a real game; and a sending unit configured to send a question message representing a question related to the specific event, to the terminal device via a communication network when the specific event occurs in the real sports game.

### CROSS-REFERENCE TO RELATED APPLICATIONS

This application is based on and claims the benefit of priority from Japanese Patent Application Serial No. 2012-110619 (filed on May 14, 2012), the contents of which are hereby incorporated by reference in their entirety.

### TECHNICAL FIELD

The present invention relates to a device for providing a video game.

### BACKGROUND

In the publicly known video game disclosed in Japanese Patent Application Publication No. 2003-19357 (the “357 Publication”), game players forecasts the winner of a sports game and obtains points when the forecast is right. The game players of the video game disclosed in the above literature can receive information on progress of the sports game after every inning for example, until the winner of the sports game is determined.

In the video game disclosed in '357 Publication, the feature of distributing information indicating the progress of the sports game to game players prevents the game players waiting for the winner to be determined from being bored, but does not encourage the game players to actively see the sports game itself. Accordingly, the video game disclosed in '357 Publication is less likely to continuously keep the game players attracted to the sports game.

### SUMMARY

To overcome this problem, various embodiments of the present invention provide a video game that attracts game players to a real sports game.

A server device according to an embodiment of the present invention is connected to a terminal device of a game player via a communication network and configured to provide a video game to the terminal device, the server device comprising: a setting unit configured to set, as a specific event, an event designated by the terminal device among events anticipated in a real game; a detecting unit configured to receive information indicating occurrence of the specific event and detect the occurrence of the specific event based on the received information; and a sending unit configured to send a question message representing a question related to the specific event, to the terminal device via the communication network when the detecting unit detects the occurrence of the specific event.

A game system according to an embodiment of the present invention comprises a terminal device and a server device, the terminal device being configured to be operated by a game player, the server device being connected to the terminal device via a communication network and configured to provide a video game to the terminal device, wherein the server device comprises: a setting unit configured to set, as a specific event, an event designated by the terminal device among events anticipated in a real game; a detecting unit configured to receive information indicating occurrence of the specific event and detect the occurrence of the specific event based on the received information; and a sending unit configured to send a question message representing a question related to the specific event, to the terminal device via the communication network when the detecting unit detects the occurrence of the specific event.

A method according to an embodiment of the present invention uses a computer and comprises the steps of: setting, as a specific event, an event designated by a terminal device of a game player among events anticipated in a real game; receiving information indicating occurrence of the specific event and detecting the occurrence of the specific event based on the received information; and sending a question message representing a question related to the specific event, to the terminal device via a communication network when the detecting unit detects the occurrence of the specific event.

Various embodiments of the present invention provide a video game that attracts game players to a real sports game.

### BRIEF DESCRIPTION OF THE DRAWINGS

FIG. 1 is a block diagram schematically illustrating the architecture of a game system according to an embodiment of the present invention.

FIG. 2 is a block diagram schematically illustrating the architecture of a terminal device according to an embodiment of the present invention.

FIG. 3 is a block diagram illustrating the functionality of a server device 10 according to an embodiment of the present invention.

FIG. 4 shows concrete examples of specific events and question messages related to the specific events; the specific events and the question messages are used by the server device according to an embodiment of the present invention.

FIG. 5 is a flow diagram showing an operation between the server device and the terminal device according to an embodiment of the present invention.

FIG. 6 shows a concrete example of a screen displayed on the terminal device according to an embodiment of the present invention.

FIG. 7 shows a concrete example of a screen displayed on the terminal device according to an embodiment of the present invention.

FIG. 8 shows a concrete example of a screen displayed on the terminal device according to an embodiment of the present invention.

FIG. 9 shows a concrete example of a screen displayed on the terminal device according to an embodiment of the present invention.

FIG. 10 shows a concrete example of a screen displayed on the terminal device according to an embodiment of the present invention.

### DESCRIPTION OF EXAMPLE EMBODIMENTS

Various embodiments of the present invention will be described hereinafter with reference to the drawings. In the drawings, the same components are denoted by the same reference numerals. The following description is based on a real professional baseball game.

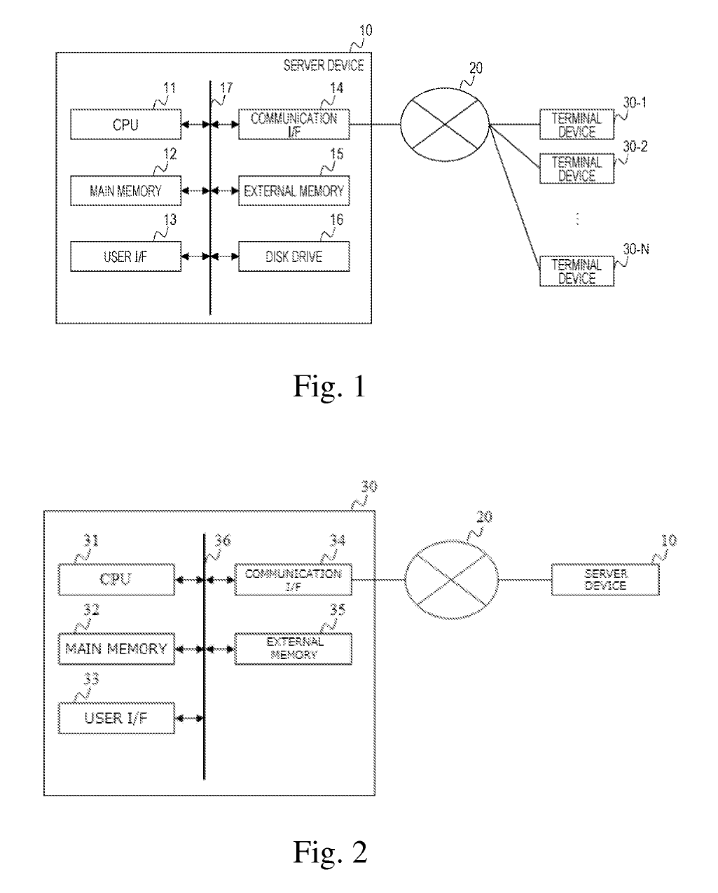

FIG. 1 is a block diagram schematically illustrating the architecture of a game system according to an embodiment of the present invention. As illustrated in FIG. 1, an online game server device 10 (hereinafter also referred to simply as the “server device 10”) may be communicatively connected to a plurality of terminal devices 30-1, 30-2, . . . , and 30-N (hereinafter also collectively referred to as the “terminal devices 30”) each having a communication function, via a communication network 20 such as the Internet. The server device 10 is an example of a device implementing part or all of a game system according to an embodiment of the present invention.

As illustrated in FIG. 1, the server device 10 may include a central processing unit (CPU) 11, a main memory 12, a user interface (I/F) 13, a communication I/F 14, an external memory 15, and a disk drive 16, and these components may be electrically connected to one another via a bus 17. The CPU 11 may load an operating system and various programs for controlling the progress of an online game into the main memory 12 from the external memory 15, and may execute commands included in the loaded programs. The main memory 12 may be used to store a program to be executed by the CPU 11, and may be formed of, for example, a dynamic random access memory (DRAM).

The user I/F 13 may include, for example, an information input device such as a keyboard or a mouse for accepting an input from an operator, and an information output device such as a liquid crystal display for outputting calculation results of the CPU 11. The communication I/F 14 may be implemented as hardware, firmware, or communication software such as a transmission control protocol/Internet protocol (TCP/IP) driver or a point-to-point protocol (PPP) driver, or a combination thereof, and may be configured to be able to communicate with the terminal device 30 via the communication network 20.

The external memory 15 may be formed of, for example, a magnetic disk drive, and store various programs such as a game program for allowing the terminal device 30 to execute an online game and a control program for controlling the progress of the online game. The game program may be created using, for example, Adobe Flash™, which is a format developed by Adobe Systems Incorporated to handle moving images, games, and the like. The game program created using Adobe Flash™ may be stored in the external memory 15 as a small web format (SWF) file. The game program will be described later. The disk drive 16 may read data stored in a storage medium such as a compact disc read only memory (CD-ROM), digital versatile disc read only memory (DVD-ROM), or DVD Recordable (DVD-R) disc, or write data to such a storage medium. For example, data of a game program or the like stored in a storage medium may be read by the disk drive 16, and may be installed into the external memory 15.

The terminal device 30 may be any information processing device capable of executing and operating a game program stored on the server device 10 and displayed on a web browser, non-limiting examples of the terminal device 30 including a mobile phone, a smartphone, a game console, a personal computer, a tablet, or an electronic book reader. Additionally, the terminal device 30 may be capable of receiving a game program from the server device 10 through a communication I/F 34 (described later) for executing the game.

The architecture of these various terminal devices 30 will be described with reference to FIG. 2. FIG. 2 is a block diagram schematically illustrating the architecture of a terminal device 30 according to an embodiment of the present invention. As illustrated in FIG. 2, the terminal device 30 may include a central processing unit (CPU) 31, a main memory 32, a user interface (I/F) 33, a communication I/F 34, and an external memory 35, and these components may be electrically connected to one another via a bus 36.

The CPU 31 may load various programs such as an operating system into the main memory 32 from the external memory 35, and may execute commands included in the loaded programs. The main memory 32 may store a program to be executed by the CPU 31, and may be formed of, for example, a dynamic random access memory (DRAM).

The user I/F 33 may include, for example, an information input device such as a touch panel, a keyboard, a button, and a mouse for accepting an input from a player (user), and an information output device such as a liquid crystal display for outputting calculation results of the CPU 31. The communication I/F 34 may be implemented as hardware, firmware, or communication software such as a transmission control protocol/Internet protocol (TCP/IP) driver or a point-to-point protocol (PPP) driver, or a combination thereof, and may be configured to be able to communicate with the server device 10 via the communication network 20.

The external memory 35 may comprise, for example, a magnetic disk drive or a flash memory and store various programs such as an operating system. When receiving a game program from the server device 10 via the communication I/F 34, the external memory 35 stores the received game program.

The terminal device 30 having such architecture may be provided with, for example, browser software for interpreting a hypertext markup language (HTML) file and displaying a screen, and plug-in software (e.g., Flash Player distributed by Adobe Systems Incorporated) incorporated in the browser software. The terminal device 30 may acquire an SWF file embedded in an HTML file from the server device 10, and execute the SWF file using the browser software and plug-in software, and therefore the user of the terminal device 30, or a game player, may be provided with a gaming function.

A game program will be described with reference to FIGS. 1 and 2. The game program may be stored on the external memory 15 of the server device 10 in various forms. For example, the game program may be provided as a piece of application software executable on various application execution platforms. The player is able to execute or operate a game application using the terminal device 30.

The external memory 15 of the server device 10 may store game programs for executing or operating various games executable or operable on the terminal device 30. The game programs may be created using, for example, script languages such as ActionScript™ and JavaScript™, or object-oriented programming languages such as Objective-C™ and Java™. The game programs may be executed and/or operated on a platform installed on the terminal device 30. A game program to be stored on the external memory 15 may be produced by modifying a web page created in a markup language such as HTML5 by using a style sheet such as Cascading Style Sheet 3 (CSS3). Such a web page created in a markup language may be executed or operated by the browser software installed on the terminal device 30. The external memory 15 of the server device 10 may store a desired number of game programs, and a game program for executing and/or operating a game selected by the terminal device 30 may be provided to a desired number of terminal devices 30 via the communication I/F 14 in accordance with control of the CPU 11. In the terminal device 30, the game program sent from the server device 10 may be received via the communication I/F 34 and transferred to the external memory 35 for storage in accordance with control of the CPU 31.

The user of the terminal device 30 may execute or operate the game program to play various games such as action games, role-playing games, interactive baseball games, and card games. The types of the games implemented by the game program are not limited to those explicitly disclosed herein. When a game is executed, for example, animation or an operation icon designated by the program may be displayed on a screen of the terminal device 30. The player may enter an instruction for causing the game to progress using an input interface (e.g., a touch screen or a button) of the terminal device 30. The instruction entered by the player may be transmitted to the server device 10 through the browser of the terminal device 30 or a platform function such as NgCore™. The terminal device 30 may send information indicating various parameters (such as the number of game points earned and information concerning obtained items) used in the game, and information indicating the status of the game (such as information specifying which mission has been fulfilled) to the server device 10, if necessary. The server device 10 may manage the progress of the individual players in the game in accordance with information received from the plurality of terminal devices 30, such as instructions, information indicating the parameters, and information indicating the statuses. Thus, each player is able to resume the interrupted game from the point where it was interrupted, on the basis of the information concerning the progress of the game held in the server device 10.

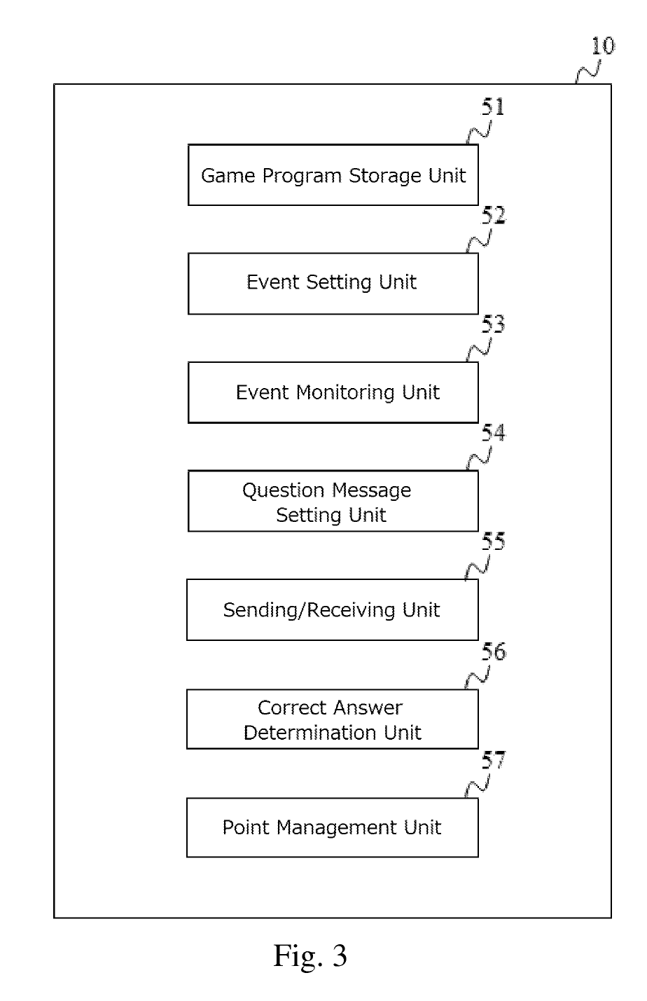

Next, the functionality of the server device 10 implemented by the components shown in FIG. 1 will be described with reference to FIG. 3. FIG. 3 is a block diagram illustrating the functionality of a server device 10 according to an embodiment of the present invention. As shown in FIG. 3, the server device 10 according to the embodiment may comprise a game program storage unit 51, an event setting unit 52, an event monitoring unit 53, a question message setting unit 54, a sending/receiving unit 55, a correct answer determination unit 56, and a point management unit 57.

The game program storage unit 51 may store game programs for performing various games that can be performed on the terminal device 30. A user of the terminal device 30 may obtain game programs stored on the game program storage unit 51 and run the obtained game programs on the terminal device 30, thereby to play the game on the terminal device 30. As stated above, various games may be performed on the terminal device 30. The games performed on the terminal device 30 may use various game media such as electronic cards, items, and virtual currency used in the games.

The event setting unit 52 may store a plurality of events that are anticipated in a real sports game (e.g., a professional baseball game). The events may include, for example, “a runner advancing to a scoring position,” “sports player A stepping into the batter's box,” “sports player B getting to a base,” “pitcher C taking the mound,” “a starting pitcher leaving the mound,” and “a pinch hitter going to bat.” At least part of these events may be either previously stored on the event setting unit 52 or received from the terminal device 30 of the game player. The event setting unit 52 may set and store “specific events” for each game player; the “specific events” may be designated by the game player among a plurality of stored events.

The event monitoring unit 53 may monitor for each game player whether a specific event set for the game player has occurred in a sports game currently in progress.

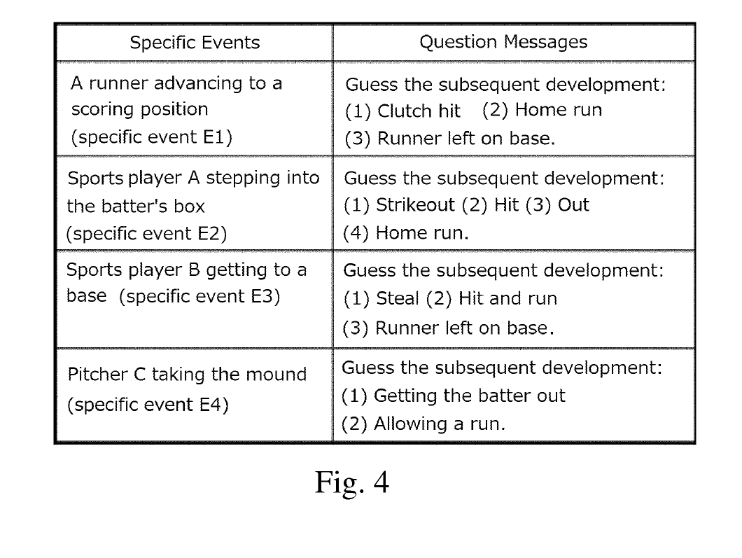

The question message setting unit 54 may set messages (question messages) representing questions related to the specific events for each game player; the messages may be sent to the terminal device 30 of the game player on occurrence of the specific events. For example, when a specific event of “a runner advancing to a scoring position” (specific event E1) occurs, as shown in FIG. 4, the question message is “Guess the subsequent development (1) Clutch hit (2) Home run (3) Runner left on base.” When a specific event of “sports player A stepping into the batter's box” (specific event E2) occurs, the question message is “Guess the subsequent development: (1) Strikeout (2) Hit (3) Out (4) Home run.” At least part of these question messages may be either designated by a question message setting unit 54 or designated by the terminal device 30 of the game player.

When a specific event for a game player occurs, the sending/receiving unit 55 may generate a web page containing a question message related to the specific event and send the web page to the terminal device 30 of the game player. Also, the sending/receiving unit 55 may send an email message or a shortmail message containing the question message to the terminal device of the game player instead of, or in addition to, sending a web page containing the question message.

Also, the sending/receiving unit 55 receives a message (an answer message) representing an answer to the question message sent to the game player, from the terminal device 30 of the game player. For example, supposing the question message is “Guess the subsequent development (1) Clutch hit (2) Home run (3) Runner left on base” as described above, and when the game player guesses that “a home run will be hit,” the answer message is, for example, “2.” The sending/receiving unit 55 can receive, as an answer message, an instruction inputted by the game player through a user interface (I/F) 33 (e.g., a touch screen or a button) of the terminal device 30. Alternatively, the sending/receiving unit 55 may receive the answer message as contained in an email message or a shortmail message.

The correct answer determination unit 56 may input and store a result with respect to the question message related to the specific event for each game player, in accordance with the progress of the sports game. For example, when a specific event of “sports player A stepping into the batter's box” occurs, and the question message is “Guess the subsequent development: (1) Strikeout (2) Hit (3) Out (4) Home run,” the result with respect to the question message related to the specific event is, for example, “4,” if sports player A hits a home run. Such a result may be obtained when an operator of the server device 10 inputs the result of sports player A's turn at bat through the user I/F 13 (e.g., a keyboard). Additionally, the correct answer determination unit 56 may determine whether an answer from the game player is correct based on the result with respect to the question message related to the specific event and the answer message received from the terminal device 30 of the game player.

The point management unit 57 manages the points provided to each game player. Also, the point management unit 57 provides points to the game player, depending on whether the answer from the game player with respect to the question related to the specific event is correct or incorrect. For example, the point management unit 57 may provide the game player with points (e.g., 100 points) only when the answer from the game player is correct. When the answer from the game player is incorrect, the point management unit 57 may also provide the game player with less points (e.g., 10 points) than provided when the answer is correct.

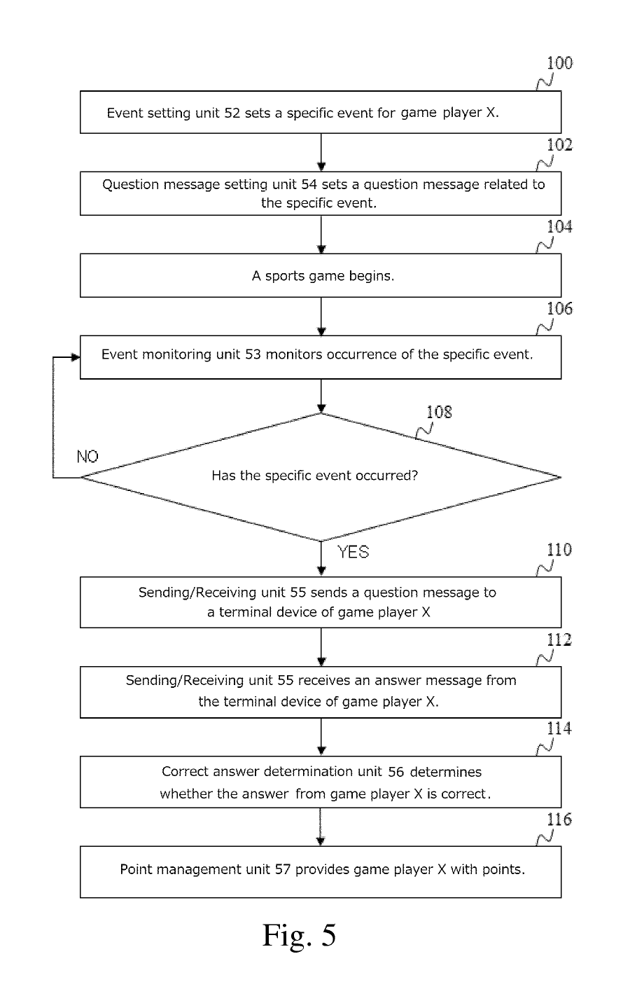

Next, FIG. 5 is referred to, so as to describe the operation between the server device 10 and the terminal device 30 of game player X for performing a game program according to the embodiment. FIG. 5 is a flow diagram showing the operation between the server device and the terminal device according to an embodiment of the present invention. The following description is based on the case where a game program is performed in connection with a sports game between professional baseball teams T1 and T2.

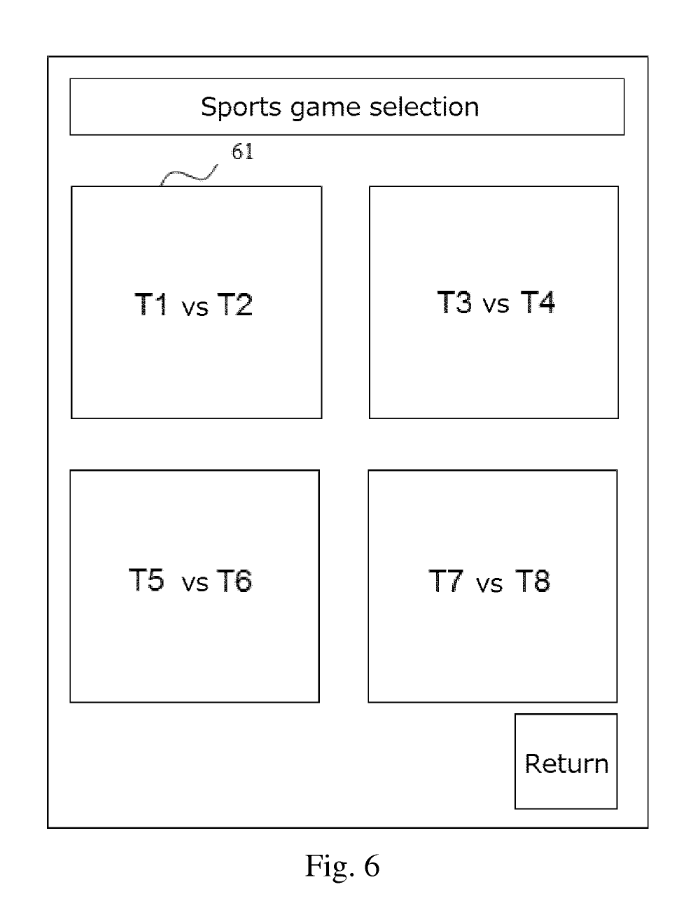

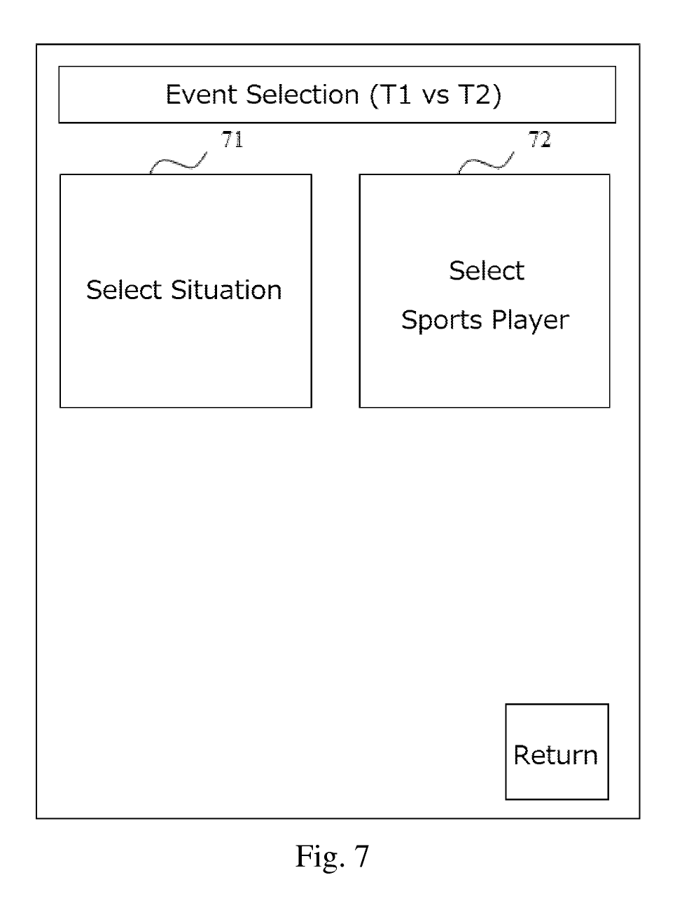

First, in step 100 (hereinafter “ST100”), the event setting unit 52 of the server device 10 may set a specific event for game player X. More specifically, the terminal device 30 of game player X may receive and interpret a file in, e.g., HTML format from the server device 10 to display a screen as shown in FIG. 6. Game player X selects the sports game between professional baseball teams T1 and T2 by touching a portion of the display of the terminal device 30 corresponding to an icon 61. In response to this operation, the terminal device 30 may display a screen as shown in FIG. 7.

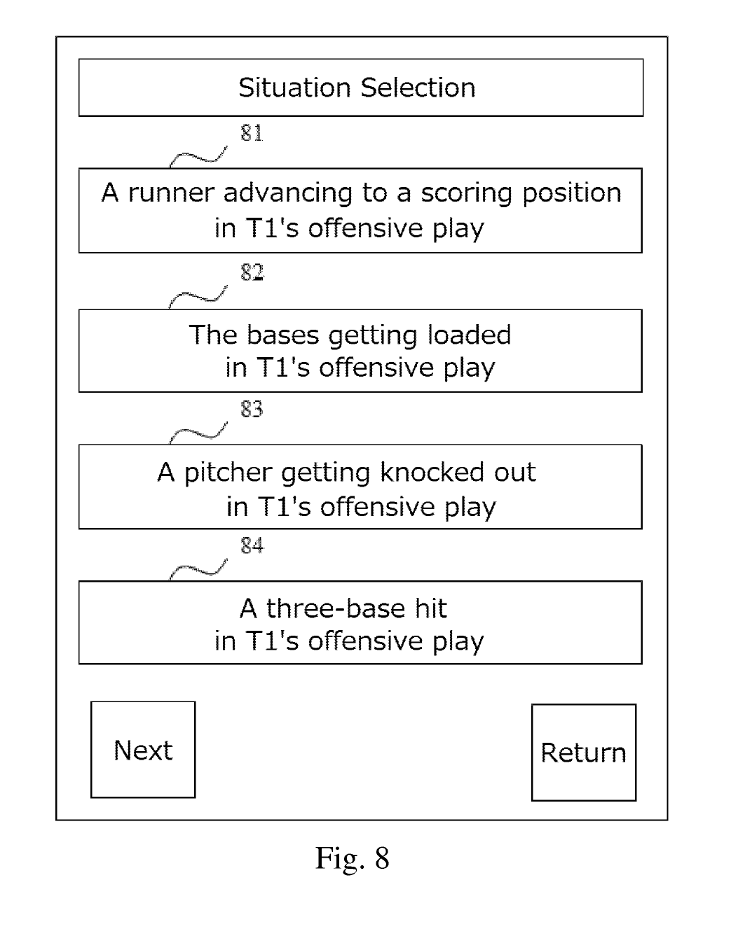

When game player X touches the icon 71 to select “Select Situation,” the terminal device 30 may display a screen as shown in FIG. 8. Game player X can designate events displayed in, e.g., icons 81 to 84 as specific events.

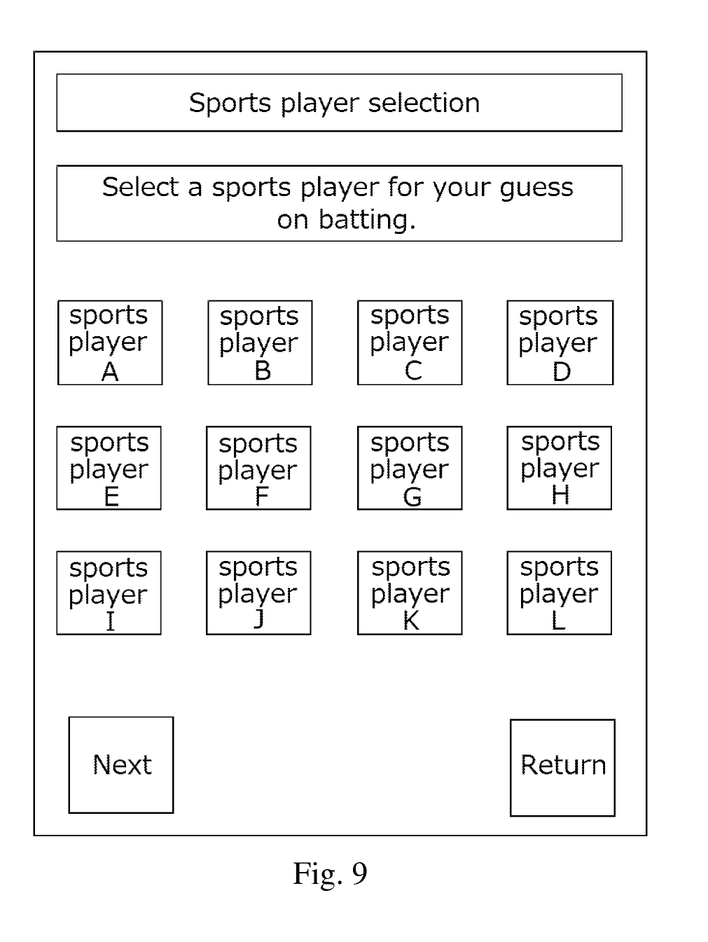

Meanwhile, when game player X touches an icon 72 in the screen shown in FIG. 7 to select “Select Sports Players,” the terminal device 30 may display a screen shown in FIG. 9. Game player X can select any one of, e.g., sports player A to sports player L displayed in the screen to designate the event of “the selected sports player stepping into the batter's box” as a specific event.

The specific event thus designated by game player X may be sent to the server device 10 by the terminal device 30. The event setting unit 52 of the server device 10 may set the specific event received from the terminal device 30 as a specific event designated by the terminal device 30. Although the above description is based on the case where game player X designates one specific event and send it to the server device 10, game player X may designate a plurality of specific events and send them to the server device 10.

Referring back to FIG. 5, in ST102, the question message setting unit 54 of the server device 10 may set a question message related to the specific event. More specifically, for example, the question message setting unit 54 may store a table containing a plurality of specific events and question messages associated with the specific events. The question message setting unit 54 may use this table to specify the question message corresponding to the specific event designated by game player X. Further, the server device 10 may receive from the terminal device 30 of game player X both the designated specific event and the question message related to the specific event, rather than the server device 10 only receives the designated specific event from the terminal device 30 of game player X. In this case, the question message related to the specific event may be selected by game player X in the same manner as shown in FIGS. 6 to 9.

Next, a sports game (T1 versus T2) begins in ST104. In ST106, the event monitoring unit 53 of the server device 10 may monitor whether the specific event designated by game player X has occurred.

More specifically, the event monitoring unit 53 may perform monitoring as follows. The event monitoring unit 53 may have a management table storing a plurality of events each associated with an event occurrence flag (the management table may be present either inside or outside the event monitoring unit 53). The operator of the server device 10 may monitor the sports game and, each time any of the plurality of events occurs, access the above management table through the user I/F 13 (see FIG. 1) and update the flag corresponding to the event that has occurred, e.g., from “00” (yet to occur) to “01” (occurred). Each time a predetermined time period elapses, the event monitoring unit 53 may access the above management table to monitor whether the flag corresponding to the specific event designated by game player X has been updated to “01.” Thus, the event monitoring unit 53 can detect whether the specific event designated by game player X has occurred.

When the event monitoring unit 53 detects that the specific event designated by game player X has occurred, the sending/receiving unit 55 may receive, in ST110, a question message corresponding to the specific event from the question message setting unit 54 and send a web page containing the question message to the terminal device 30 of game player X.

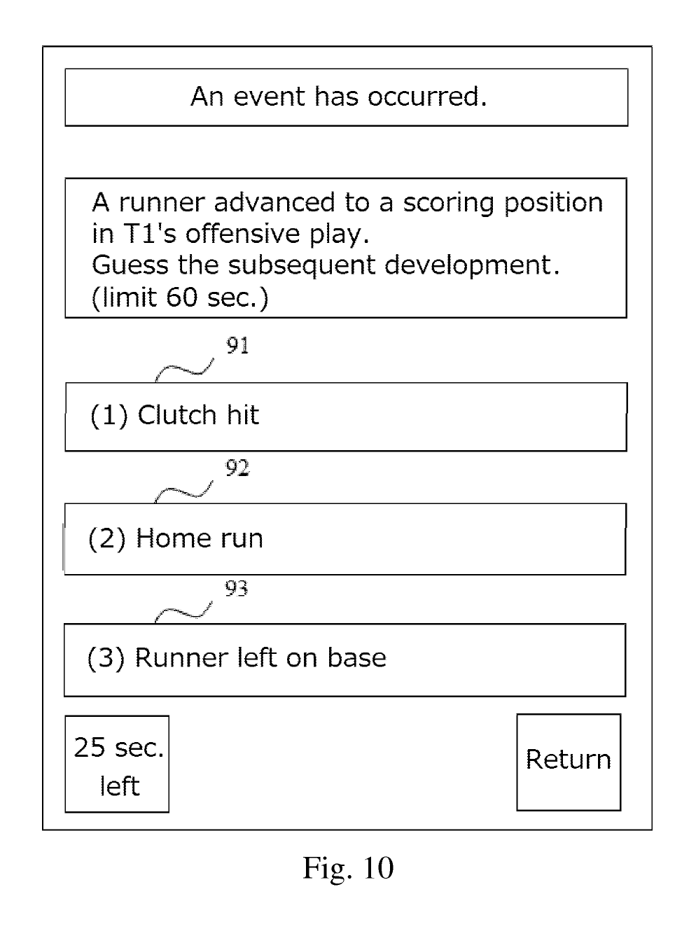

The terminal device 30 may receive the web page containing the question message and display, for example, a screen as shown in FIG. 10. In this example, the specific event is “a runner advancing to a scoring position”; and the question message related to this specific event is “Guess the subsequent development: (1) Clutch hit (2) Home run (3) Runner left on base” (see FIG. 4). Game player X may touch any of icons 91 to 93 to select one of the options (1) to (3). This screen may be controlled such that game player X confirms the answer within a time limit (60 seconds in this case). In ST112, in accordance with the result of selection, an answer message representing an answer to the question message is sent from the terminal device 30 to the server device 10 (the answer message is one of “00,” “01,” and “10” corresponding to the options (1) to (3), respectively). The server device 10 may collect the answers from a plurality of game players including game player X and send the collected result or progress of collection to the terminal devices of the game players.

Next, in ST114, the correct answer determination unit 56 of the server device 10 may determine whether the answer from game player X is correct or incorrect based on the result with respect to the question message related to the specific event and the answer message received from the terminal device 30 of game player X.

More specifically, the correct answer determination unit 56 may determine the correct answer as follows. The correct answer determination unit 56 may have a management table that stores a plurality of specific events, question messages associated with the plurality of specific events, and the results with respect to the plurality of question messages (the management table may be present either inside or outside the correct answer determination unit 56). The operator of the server device 10 may monitor the sports game and, each time any of the plurality of specific events occurs, access the above management table through the user I/F 13 (see FIG. 1) and input the correct answer in accordance with the result with respect to the question message related to the event that has occurred (the correct answer is, for example, one of “00,” “01,” and “10” for options (1) to (3), respectively). The correct answer determination unit 56 may access the above management table and compare the answer message (e.g., “00,” “01,” or “10”) received from the terminal device 30 of game player X with the result (e.g., “00,” “01,” or “10”) stored on the above management table, thereby determining whether the answer from game player X is correct or incorrect.

Next, in ST116, the point management unit 57 of the server device 10 may provide game player X with points in accordance with the answer from game player X. For example, the point management unit 57 may provide the game player with points (e.g., 100 points) only when the answer from the game player is correct. When the answer from the game player is incorrect, the point management unit 57 may also provide the game player with less points (e.g., 10 points) than provided when the answer is correct. Additionally, the point management unit 57 may determine the point to be provided to game player X in accordance with the time period (“required time”) from the point when the question message is sent from the sending/receiving unit 55 to the terminal device 30 of game player X, to the point when the answer message sent from the terminal device 30 is received by the sending/receiving unit 55. For example, the point management unit 57 may provide the game player with points inversely proportional to the required time (the more points are provided when the required time is shorter). This prevents game players from sending answer messages immediately before or after the result appears in the sports game with respect to the question message related to the specific event so as to earn points. The point management unit 57 may determine the points to be provided to game player X in accordance with the occurrence probability of the event anticipated by the answer. For example, the points provided when sports player A who hits fewer home runs hits a home run may be larger than the points provided when sports player B who hits more home runs hits a home run; these points may be provided to a game player who has answered correctly. This causes game players to answer the questions strategically.

FIG. 5 is based on an example case where specific events and/or question messages are set before the sports game begins; however, specific events and/or question messages may be set after the sports game begins and before the specific events occur.

The points obtained by the game player while the game program according to this embodiment is being performed may be reflected on the platform where this game program or other various game programs are performed. Further, the ranking determined based on the points (or the number or percentage of correct answers) obtained by the game player while the game program according to this embodiment is being performed may be displayed in the platform. Furthermore, an achievement (badge) may be provided to the game player based on the points obtained by the game player while the game program according to this embodiment is being performed.

The above description is based on the configuration where the server device sends question messages related to a specific event to the terminal device of the game player when the specific event designated by the game player occurs. Instead, when a specific event designated by the game player occurs, the server device may only notify the terminal device of the game player of fact that the specific event has occurred. In this configuration, if a game player designates, e.g., a specific event of “a favorite sports player stepping into the batter's box,” the game player can normally study or work and, each time the sports player steps into the batter's box, the game player can receive notification from the server device and see the sports game on TV or check the progress of the sports game on a web browser.

The above description is based on a case where the game program according to this embodiment is performed in connection with a baseball game by way of an example. However, the game program according to this embodiment can be performed in connection with various sports games including softball, soccer, table tennis, basketball, rugby, football, kendo, judo, and marathon. Further, the game program according to this embodiment can be performed in connection with various real games other than sports games.

Thus, in various embodiments of the present invention, a game player may designate a specific event among a plurality of events anticipated in a real sports game and, when the specific event actually occurs, the game player may be notified of the fact that the specific event has occurred and/or receive a question message related to the specific event. The specific event is designated by the game player and thus attracts the game player; therefore, when the game player is notified of the fact that the specific event has occurred and/or receives a question message related to the specific event, the game player is led to immediately see the sports game performed in real time. This attracts game players to a real sports game. Further, if the game player designates a plurality of specific events or designates a specific event that may occur a plurality of times (e.g., specific events of “a certain sports player stepping into the batter's box” or “a runner advancing to a scoring position”), the game player is continuously attracted to the real sports game.

The processes and procedures described and illustrated herein are implemented by software, hardware, or any combination thereof, as well as that explicitly stated in the embodiments. More specifically, the processes and procedures described and illustrated herein are implemented by the installation of the logic corresponding to the processes into a medium such as an integrated circuit, a volatile memory, a non-volatile memory, a magnetic disk, or an optical storage. The processes and procedures described and illustrated herein may also be installed in the form of a computer program, and executed by various computers.

The processes and procedures described and illustrated herein to be executed by a single device, software piece, component, or module may also be executed by a plurality of devices, software pieces, components, and/or modules. The data, table, or database described and illustrated herein to be stored in a single memory may also be distributed to and stored in a plurality of memories included in a single device or a plurality of memories which are located in a plurality of devices in a distributed manner. Furthermore, the elements of the software and hardware described and illustrated herein may also be integrated into a smaller number of constituent elements or separated into a larger number of constituent elements.

If it is herein described that the invention comprises one element or a plurality of elements, the invention may comprise either one element or a plurality of elements.

What is claimed is:

1. A server device connected to a terminal device of a game player via a communication network and configured to provide a video game to the terminal device, the server device comprising:
a setting unit configured to set, as a specific event, an event designated by the terminal device among events anticipated in a real game;
a detecting unit configured to receive information indicating occurrence of the specific event and detect the occurrence of the specific event based on the received information; and
a sending unit configured to send a question message representing a question related to the specific event, to the terminal device via the communication network when the detecting unit detects the occurrence of the specific event.

2. The device of claim 1, further comprising a receiving unit configured to receive an answer message representing an answer to the question message from the terminal device via the communication network.

3. The device of claim 2, further comprising a determination unit configured to receive information indicating a result of the specific event related to the question represented by the question message, the information being received as a correct answer to the question, and to determine, based on the received information, whether the answer represented by the answer message received from the terminal device is a correct answer.

4. The device of claim 3, further comprising a providing unit configured to provide the game player with points when the determination unit determines that the answer is correct.

5. The device of claim 4, wherein the providing unit determines the points based on the time period from the point when the sending unit sends the question message to the point when the receiving unit receives the answer message representing the answer to the question message.

6. A game system comprising a terminal device and a server device, the terminal device being configured to be operated by a game player, the server device being connected to the terminal device via a communication network and configured to provide a video game to the terminal device, wherein the server device comprises:
a setting unit configured to set, as a specific event, an event designated by the terminal device among events anticipated in a real game;
a detecting unit configured to receive information indicating occurrence of the specific event and detect the occurrence of the specific event based on the received information; and
a sending unit configured to send a question message representing a question related to the specific event, to the terminal device via the communication network when the detecting unit detects the occurrence of the specific event.

7. A method using a computer comprising the steps of:
setting, as a specific event, an event designated by a terminal device of a game player among events anticipated in a real game;
receiving information indicating occurrence of the specific event and detecting the occurrence of the specific event based on the received information; and
sending a question message representing a question related to the specific event, to the terminal device via a communication network when the detecting unit detects the occurrence of the specific event.
